(19) United States
(12) Patent Application Publication
(10) Pub. No.: US 2012/0211302 A1
(43) Pub. Date: Aug. 23, 2012

(54) ARTICULATING WORK PLATFORM AND HITCH ASSEMBLY

(75) Inventor: J. Aubrey Stewart, New Glasgow (CA)

(73) Assignee: IDEAL ENGINEERING, INC., New Glasgow, Novia Scotia (CA)

(21) Appl. No.: 13/496,318

(22) PCT Filed: May 7, 2010
(86) PCT No.: PCT/IB10/01317

§ 371 Date: May 8, 2012

Related U.S. Application Data
(60) Provisional application No. 61/242,481, filed on Sep. 15, 2009.

(51) Int. Cl. B60D 1/44; B23P 11/00; E04G 1/20; B60D 1/46; E04G 1/28; E04G 1/24

(52) U.S. Cl. 182/12; 182/129; 280/467; 29/428

(57) ABSTRACT

A work platform capable of attachment to a hitch on a vehicle includes a substantially rectangular frame having a base extending along a plane and an extension arm coupling the frame to the hitch and configured to enable adjustment of the distance of the frame relative to the hitch. An elevation mechanism coupled to the frame and the attachment mechanism is configured to enable adjustment of the height of the frame relative to the plane of the hitch while an orientation mechanism coupled to the frame and configured to enable adjustment of the orientation of the frame relative to the hitch axis. The work platform may further include an angular adjustment mechanism coupled to the extension arm for modifying the angular adjustment of the work platform along an axis transverse to the vehicle centerline. The frame it may be covered on multiple sides to form an enclosed basket-like workspace.

### CROSS REFERENCE TO RELATED APPLICATIONS

This application is a U.S. national stage continuation-in-part application under 35 U.S.C. 371 of PCT/IB2010/001317 filed May 7, 2010, which in turn claims priority to U.S. Provisional Patent Application No. 61/242,481, filed Sep. 15, 2009, the subject matters of which are incorporated herein by these references in their entirety for all purposes.

### FIELD OF THE INVENTION

The disclosure relates to maintenance vehicles, and more particularly, to a work platform attachable to a vehicle.

### BACKGROUND OF THE INVENTION

Vehicles used in construction and maintenance often require some type of work platform from which an operator can perform the distribution or collection of objects or substances, such as pylons or cones along a road way. Vehicles with specialized apparatus for distribution or collection of such objects are often prohibitively expensive to acquire and maintain, especially for many municipal, state and federal agencies. Such tasks can be achieved using non-specialized equipment, such as a flatbed truck or pickup truck, however, the process is less efficient. In addition, the safety of the public, as well as the operator are always of paramount concern.

Accordingly, a need exists for a work platform which can be used with existing vehicles which have a standard Reese hitch, or other type of hitch, which provides a multi-position work platform near the surface of a roadway or ground.

A further need exists in work platform which protects the passenger or operator during operation thereof.

A still further need exists for a work platform that can be easily repositioned to either side of the vehicle as necessary for the intended activity.

A further need exists for a work platform which is sturdy, yet lightweight, and can be rapidly coupled or uncoupled to/from a standard vehicle.

A further need exists for a work platform which can be rapidly assembled and disassembled for transport when not in use.

### SUMMARY OF THE INVENTION

Disclosed is an articulating work platform designed to attach to a vehicle, such as a pickup truck, via a standard Reese hitch assembly of a vehicle without modification or with minimal modification to the vehicle hitch. The work platform mounted on the front, side or rear of the vehicle and may articulate from an extreme right ankle to an extreme left ankle position relative to the vehicle hitch. According to one embodiment, a work platform capable of attachment to a hitch on a vehicle comprises: A) a substantially rectangular frame having a base extending along a plane; B) an extension arm coupling the frame to the hitch and configured to enable adjustment of the distance of the frame relative to the hitch; C) an elevation mechanism coupled to the frame and the attachment mechanism and configured to enable adjustment of the height of the frame relative to the plane of the hitch; and D) an orientation mechanism coupled to the frame and configured to enable adjustment of the orientation of the frame relative to the hitch axis. The work platform may further comprise an angular adjustment mechanism coupled to the extension arm for modifying the angular adjustment of the work platform along an axis which is one of transverse or parallel to the vehicle centerline. The frame it may be covered on multiple sides to form an enclosed frame-like workspace.

According to another embodiment, a work platform capable of attachment to a hitch comprises A) a substantially rectangular-shaped frame; and B) an attachment mechanism for movably coupling the frame to a hitch of a vehicle in a manner that allows multiple degrees of motion of the frame relative to the hitch. The attachment mechanism is configured to enable adjustment of the frame height, distance and orientation relative to the hitch.

In yet another embodiment, a method of attaching a work platform to a vehicle hitch comprises: A) providing a work platform comprising: i) a substantially rectangular-shaped frame; ii) an attachment mechanism for movably coupling the frame to enable multiple degrees of motion of the frame relative to the hitch; and B) attaching the work platform to the vehicle hitch. The adjustment mechanism can be configured to modify the angular adjustment of the work platform along an axis which is one of transverse or parallel to the vehicle centerline, or any of the height, distance or orientation of the work platform relative to the vehicle hitch.

### BRIEF DESCRIPTION OF THE DRAWINGS

FIGS. 1-4 illustrate rear isometric, front isometric, side, and bottom views, respectively, of one embodiment of the disclosed articulating mounted platform in accordance with the disclosure;

FIG. 5 illustrate a rear isometric views of an alternative embodiment of the disclosed articulating mounted platform in accordance with the disclosure;

FIG. 6 illustrates conceptually an exploded perspective view of a work platform and attachment mechanisms relative to a vehicle, in accordance with the disclosure;

FIG. 7 illustrates a close-up perspective view of coupling between a work platform and attachment mechanisms, in accordance with the disclosure;

FIGS. 8A-C illustrate side, bottom perspective and front perspective views, respectively, of a motorized articulating assembly in according with the disclosure;

FIGS. 9A-C illustrate isometric, side and front views, respectively, of a quick connect assembly according to another embodiment of the disclosure;

FIG. 10 illustrates an isometric view of a quick connect assembly according to another embodiment of the disclosure;

FIGS. 11A-D illustrate right side, left side, top and isometric views, respectively, of an alternative hitch and angular adjustment assembly according to one embodiment of the disclosure;

FIG. 12 illustrates a rear isometric views of an alternative embodiment of the disclosed articulating mounted platform in accordance with the disclosure;

FIGS. 13A-D illustrate right side, left side, top and isometric views, respectively, of an angular adjustment assembly according to one embodiment of the disclosure;

FIG. 14 illustrates schematically the electrical connections useful with the embodiments of work platform disclosed herein;

FIG. 15 illustrates a front view of an alternative embodiment of the disclosed articulating mounted platform in accordance with the disclosure;

FIG. 16 illustrates a close-up perspective view of a connection assembly configured to couple work platforms to a vehicle, in accordance with the disclosure; and

FIG. 17 illustrates a top view of a truck towing a trailer having work platforms coupled thereto, in accordance with the disclosure.

### DETAILED DESCRIPTION

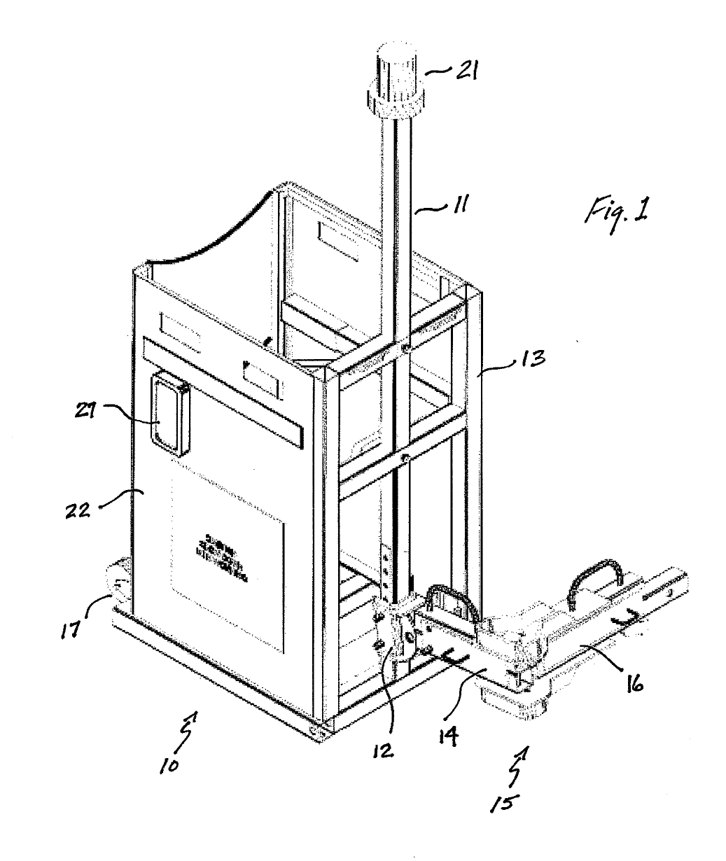

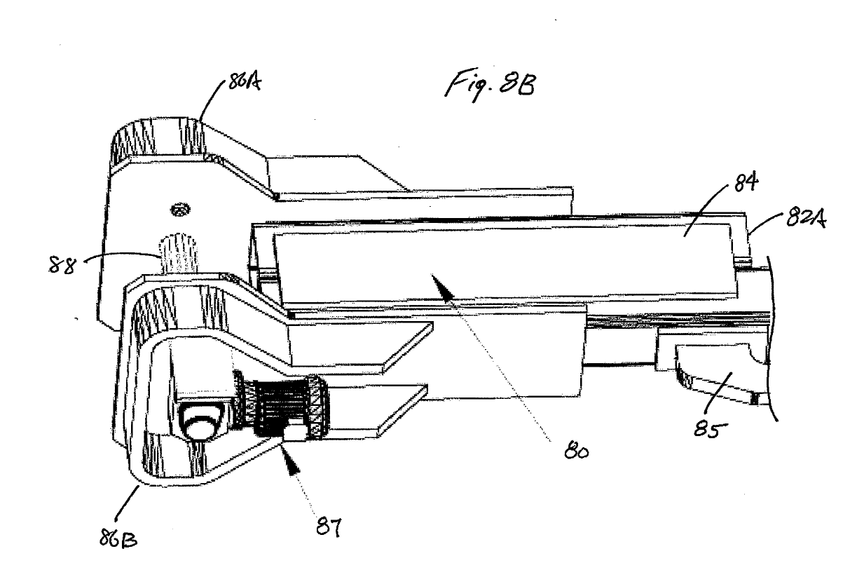

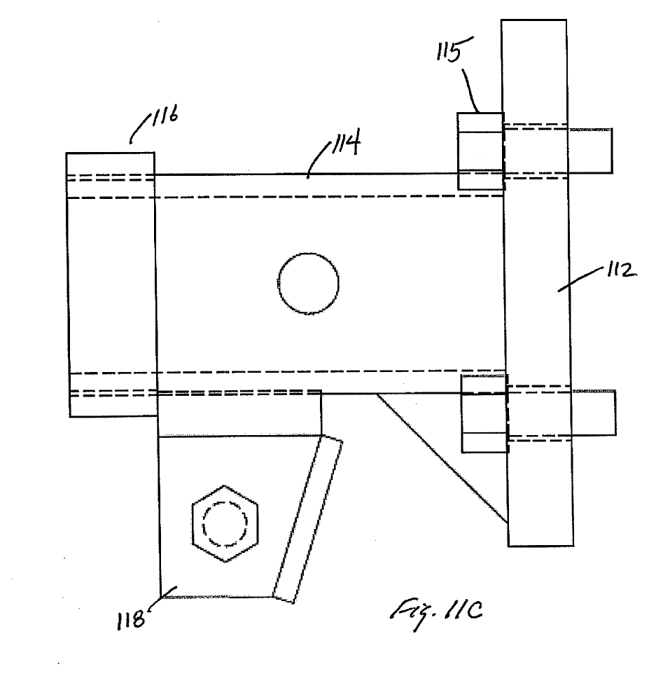

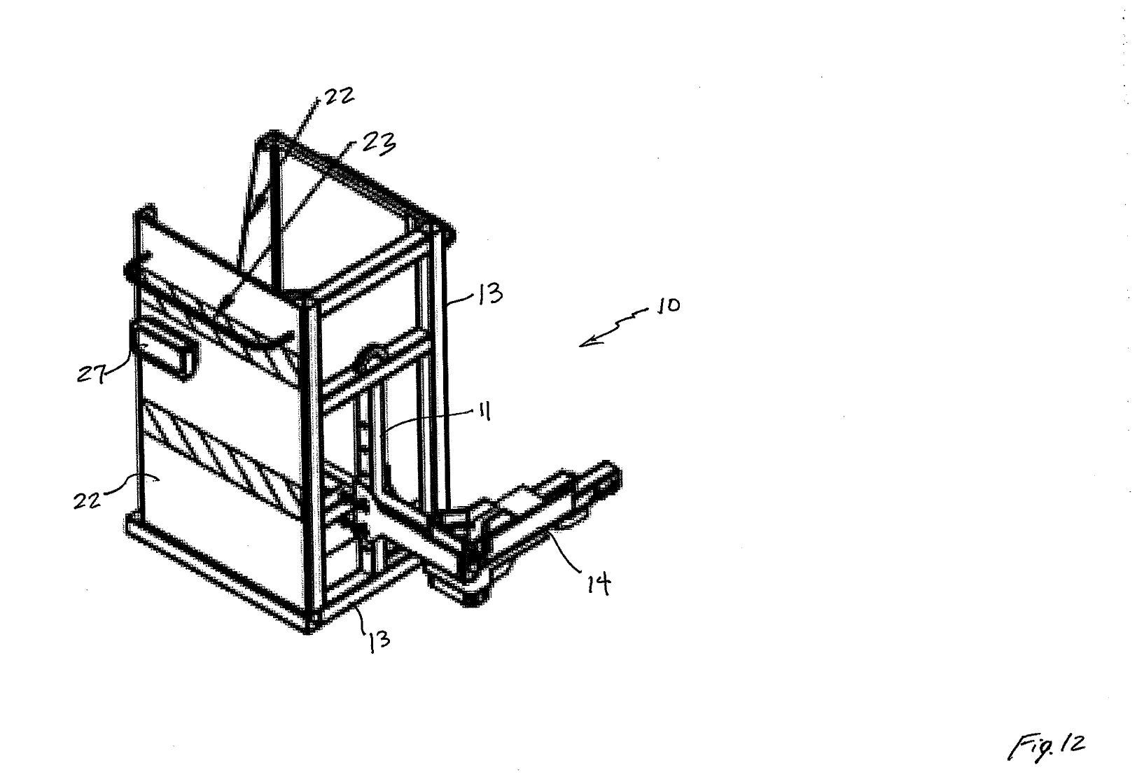

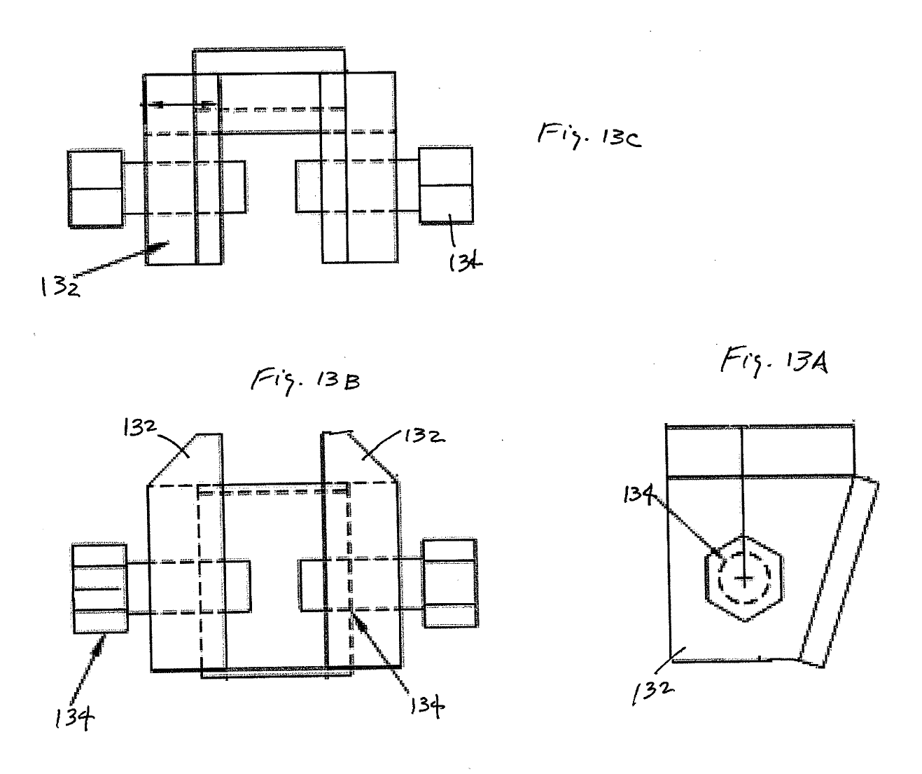

Referring to FIG. 6, a system 5 comprises a work platform 10 and connection assembly 15 for securing the work platform 10 to a vehicle 6. Work platform 10, as illustrated With reference FIGS. 1-5 and 12, may have embodiments with various configurations, as described herein. Connection assembly 15, as illustrated in the figures, comprises a quick connect assembly 12, an extension arm assembly 14, and articulated hitch assembly 16 and an angle adjustment assembly 18. Angle adjustment assembly 18 may comprise an assembly 130 separately securable to the hitch 8 of a vehicle 6, in one embodiment as illustrated in FIGS. 13A-D, or, in another embodiment, may comprise part of a separately installable hitch and angle adjustment assembly 110, as illustrated in FIGS. 11A-D.

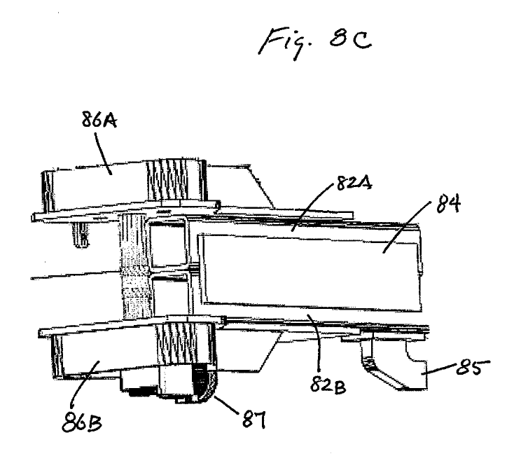

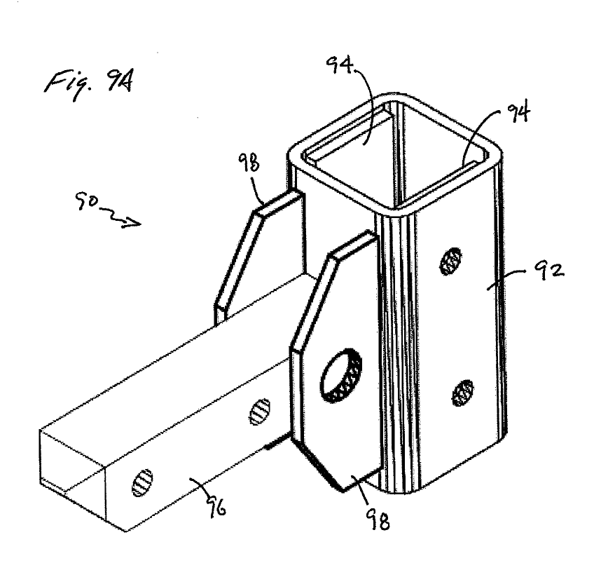

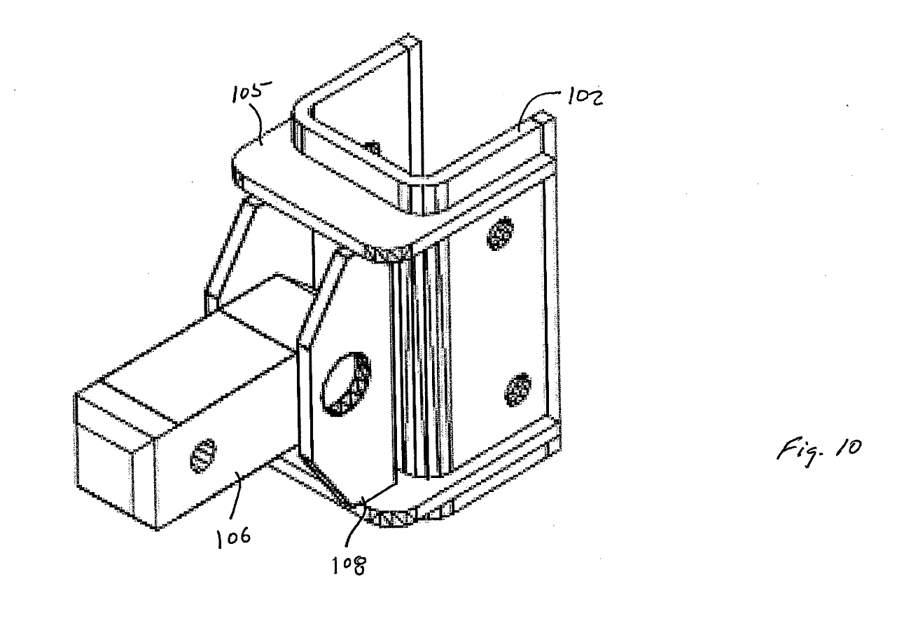

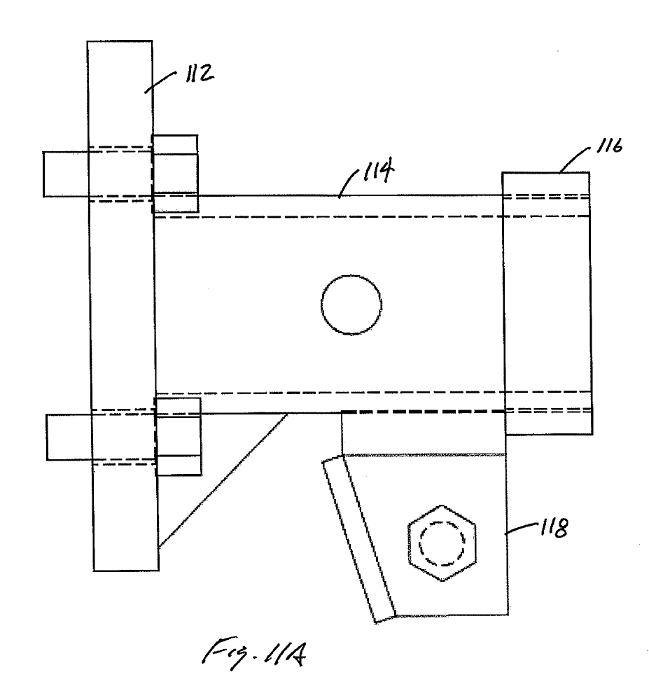

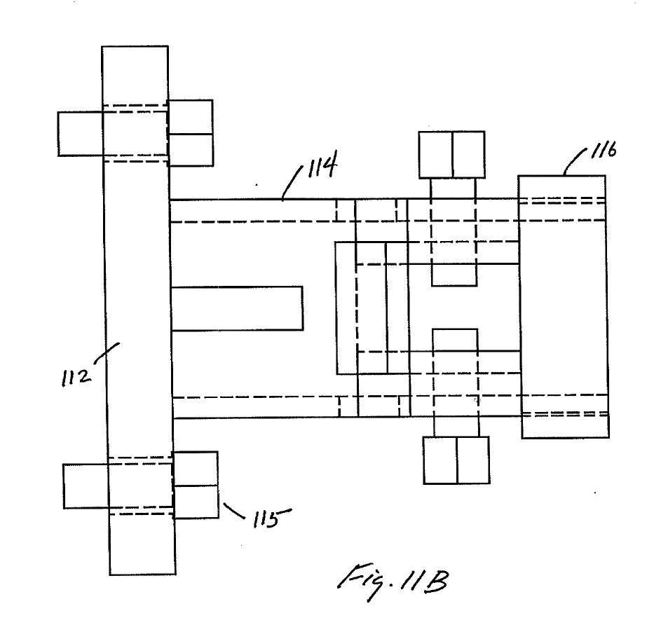

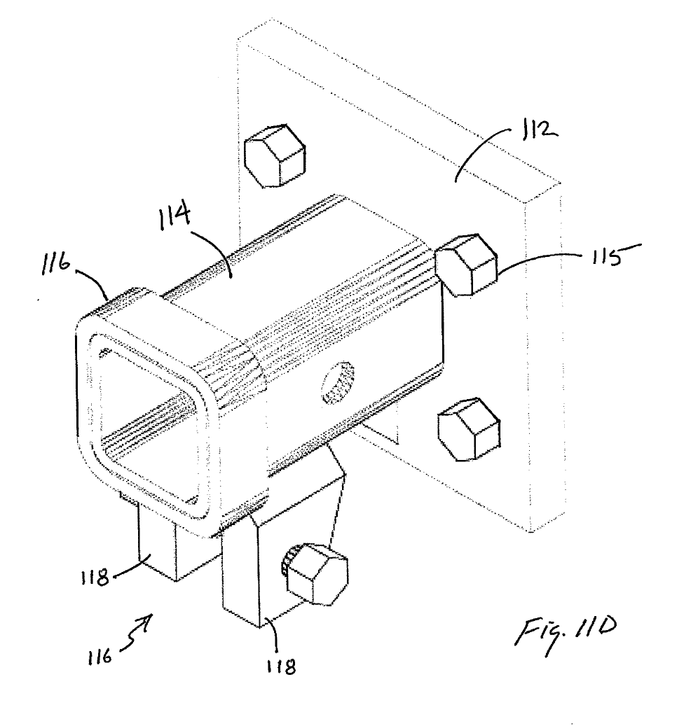

FIG. 7 illustrates a close-up perspective view of coupling between a work platform 10, quick connect assembly 12 and extension arm assembly 14, and articulating hitch assembly 16 in accordance with the disclosure. Quick connect assembly 12 is slidably mounted to the frame of work platform 10 using a plurality of pins so as to allow the height of work platform 10 to be adjusted relative thereto the other components of connection assembly 15 and the vehicle hitch. An insert of quick connect assembly 12 is received within extension arm assembly 14. Assemblies 12 and 14 may be secured together using one or more pins as illustrated. Assembly 12 may comprise either of the configurations described with reference to FIGS. 9 and 10, or, alternatively, as illustrated in FIG. 12.

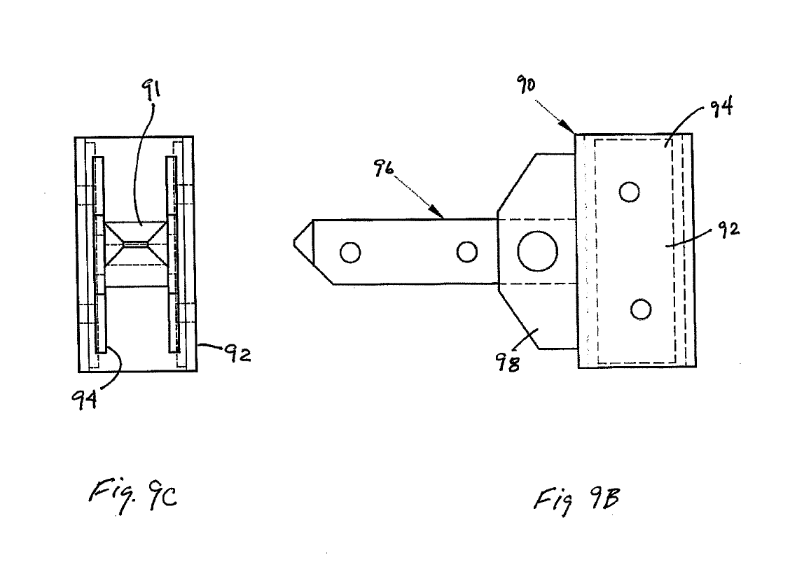

Extension arm assembly 14 is pivotally mounted to articulated hitch assembly 16 to allow the combination of the extension arm assembly 14, quick connect assembly 12 and work platform 10 to be continuously rotated relative to the axis of assembly 16 between opposing positions which are approximately 180° apart and at great angles to the axis of assembly 16 and the vehicle hitch. The extension arm assembly 14 comprises a plurality of rectangular tubes 34 stacked vertically at a length designed to locate the work platform 10 approximately flush with the outside of the vehicle 6. Assemblers 14 and 16 are removably secured using one or more pins 36, as illustrated. An arm of articulated hitch assembly 16 is received within the vehicle hitch and its angular motion of constrained by angular adjustment assembly 18, as described herein. Articulated hitch assembly 16 is designed to allow the extension arm assembly 14 to fit in the assembly and be locked into position by one or more lock pins 36. Such design also allows for operation from both the drivers side and the passenger side of vehicle 6, is described in greater detail with reference to FIGS. 8A-C. As used herein, the term “pins” may comprise any us straight pins, L-shaped pins or cotter pins, as illustrated in figures.

Referring again to FIG. 6-7, the work platform 10 is attached to a vehicle 6 by way of connection assembly 15 which designed to allow the work platform 10 to be raised or lowered relative to the road surface (or hitch). The connection assembly 15 can be of varying lengths so as to accommodate the requirements of the vehicle width and fits into the vehicle hitch 8 and allows the work platform 10 to rotate 180 degrees so work can be preformed from either side of the vehicle 6.

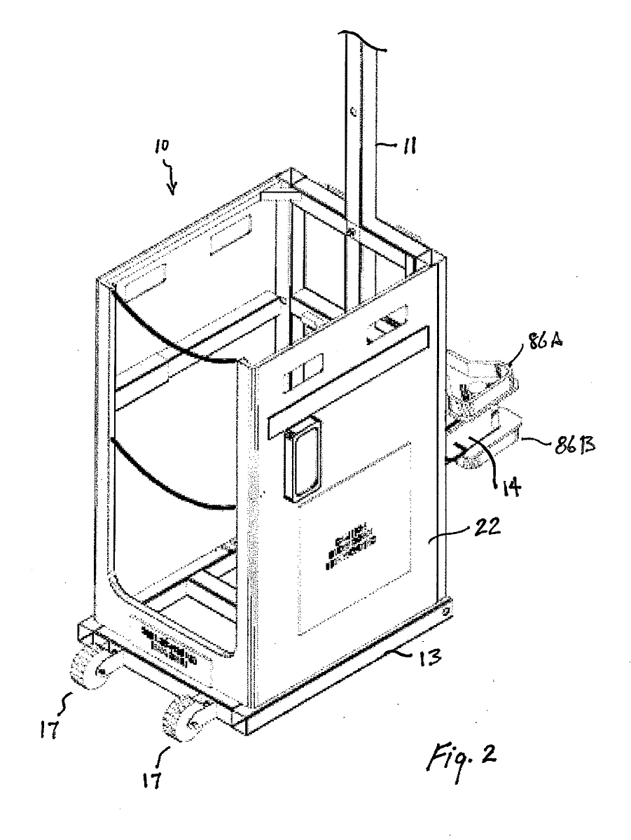

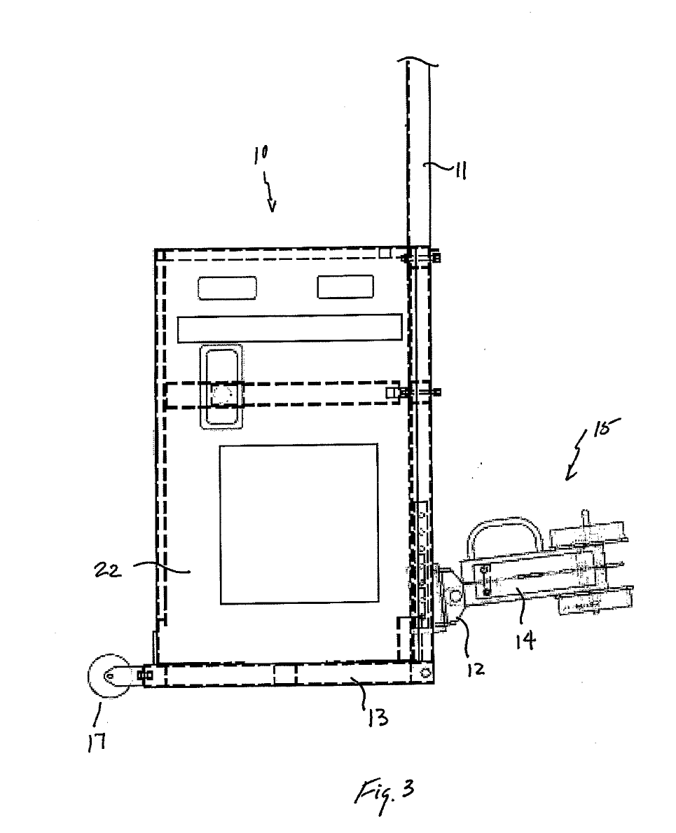

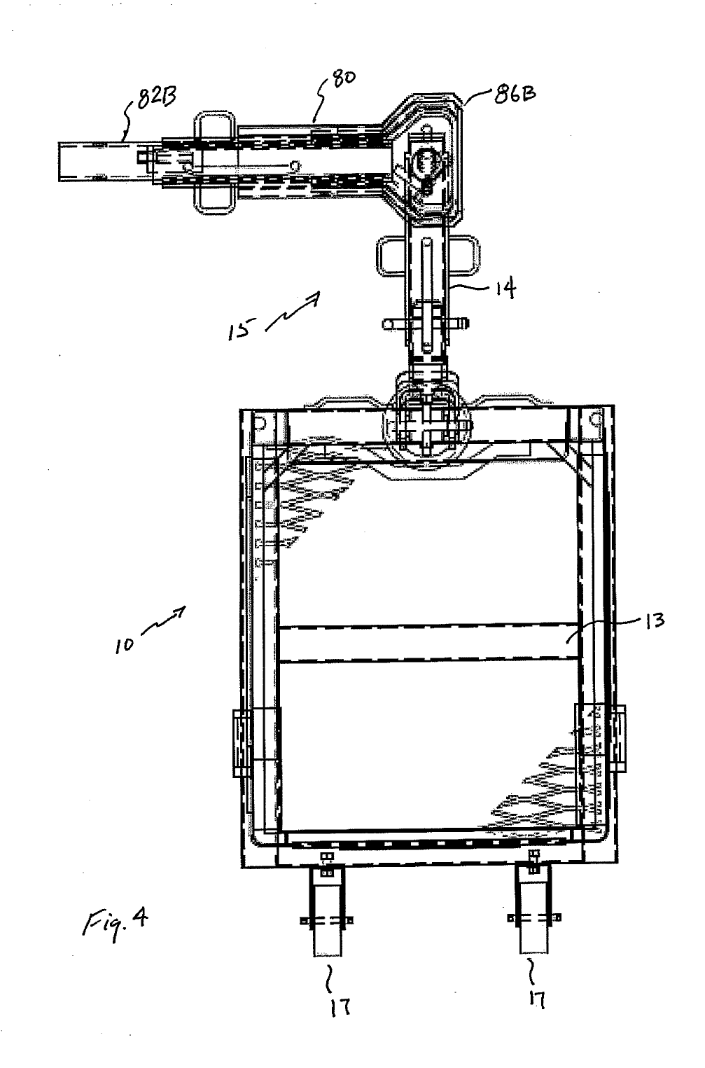

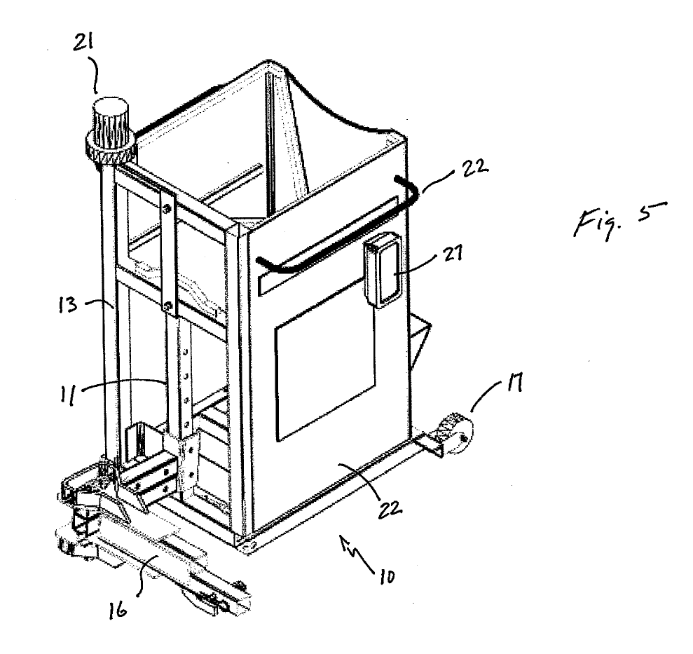

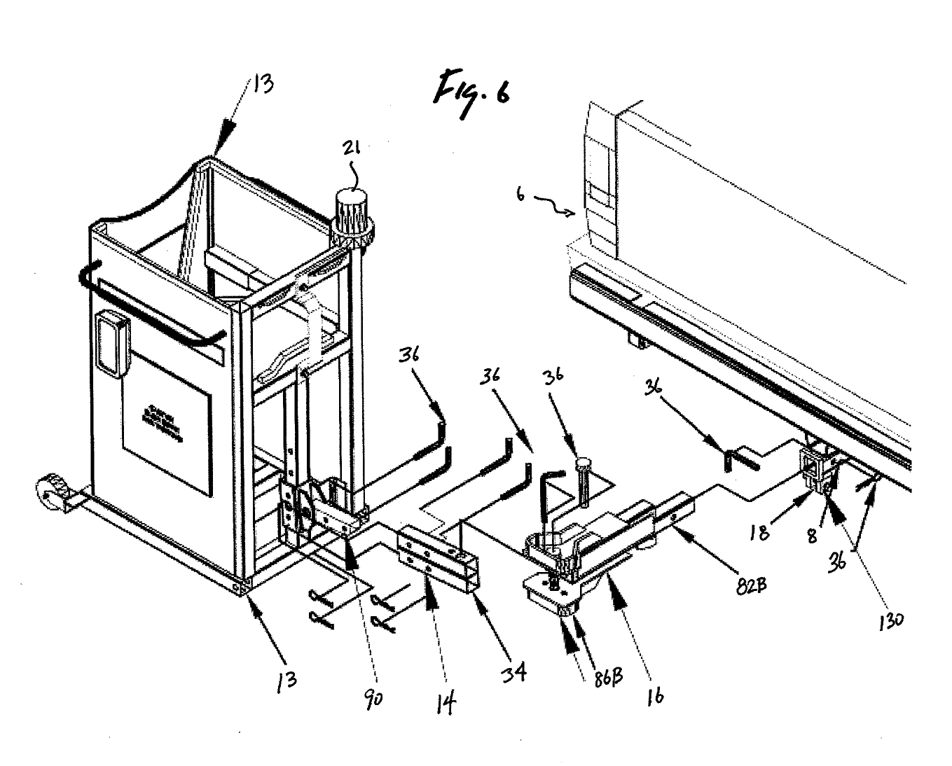

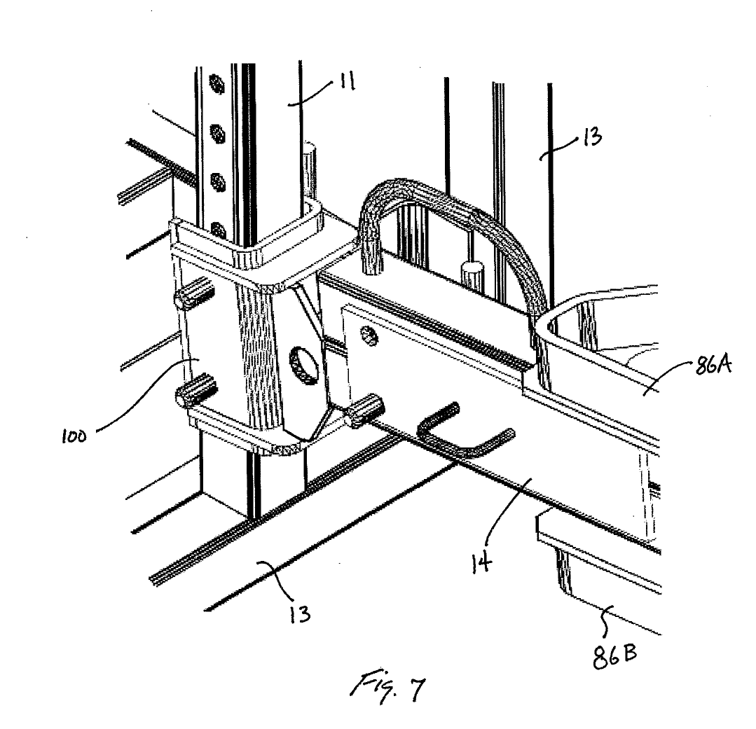

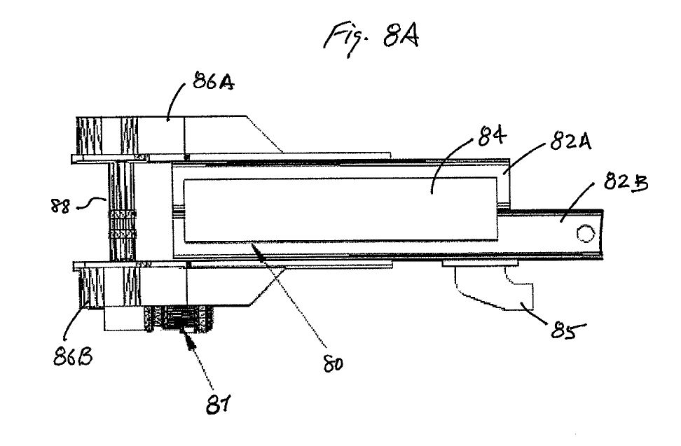

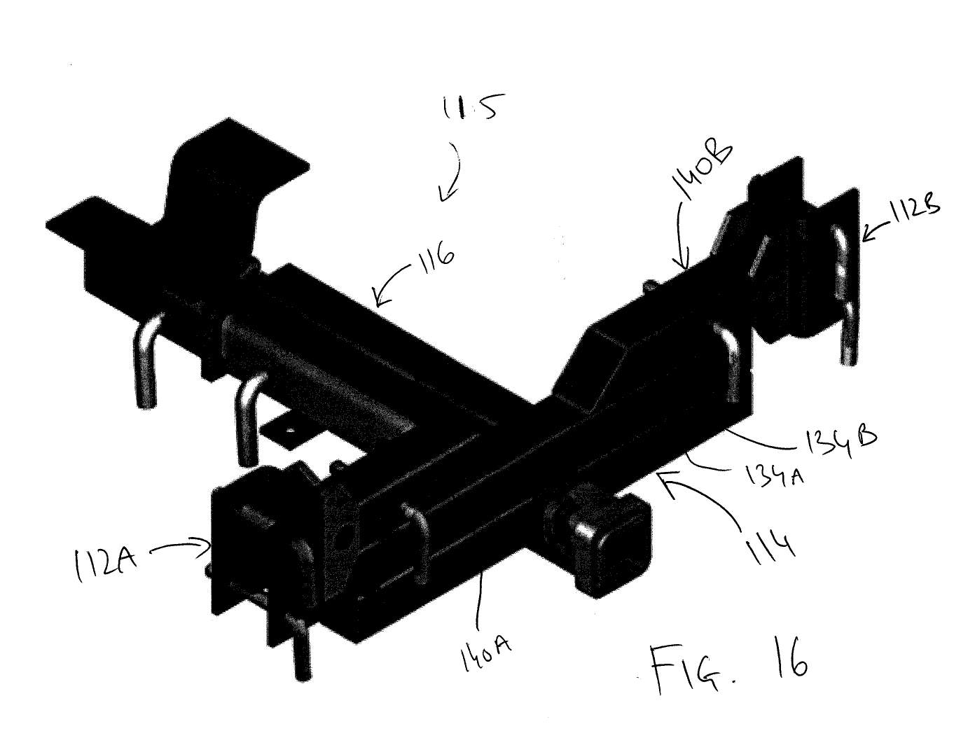

FIGS. 1-4 illustrate rear isometric, front isometric, side, and bottom views, respectively, of one embodiment of work platform 10. In its most basic embodiment, work platform 10 comprises a rectangular frame 13 which may be assembled from multiple tubular pieces of a light but rigid material, such as aluminum, such as with welding, screws, or other fastening mechanisms. Frame 13 defines a work space in which the operator will reside during use thereof. In one embodiment, one or more optional vertical sides 22 partially enclose the work space and may be of varying heights to accommodate the requirements of a specific task. The width of work platform 10 can be of various sizes to accommodate the needs of a specific task. A floor surface 23 of the workspace may comprise corrugated aluminum or and aluminum mesh secured to the bottom portion of the frame 13 defining the workspace, as illustrated in FIG. 4. Referring to FIG. 2, an open side of work platform 10 allows the operator to enter and exit the work space and may include a mechanism for retaining the operator within a workspace, including one or more chains, as illustrated, or, alternatively, a door or the equivalent retention devices. A set of optional wheels 17 may be secured to frame 13 to allow the work platform 10 to be tilted and rolled for rapid transporting thereof, as illustrated. Work platform 10 may have handles 23 integrally formed into sides 22, as illustrated in FIGS. 1-2, to or secured to the exterior art there off, as illustrated in FIGS. 5 and 6. As explained hereinafter with reference to FIG. 16, were more lights 19 may be attached to the exterior of work platform 10, in addition to reflectors or various other safety devices, including a lanyard attachable frame 13 for tethering the operator within the workspace.

The work platform 10 is designed to provide a maximum safe working load of approximately 300 lbs with a factor of safety of 5 based on 50% of the material yield stress, and comes with optional hand grabs 23 and an anchor point of a lanyard and safety belt. The exterior of the work platform 10 has functioning signal lights 31 to provide brake, turning, and running lights. Also, reflectors are applied to the platform to increase visibility. The work platform 10 may have a built in top rail, and rear kick plate sides 22a-d covered with metal sheeting.

As illustrated in FIGS. 1 and 5, frame 13 comprises a height adjustment bar 11 having a plurality of apertures extending therethrough to which quick connect assembly 12 may be selectively secured using one or more pins, as illustrated. In the embodiments disclosed in FIGS. 1 and 2, the height adjustment bar 11 further serves as a post for securing light 21 which may be any nature of warning lights include continue including continuous, rotating, strobe, etc. as well as any color depending on the nature of the activity.

FIG. 5 illustrate a rear isometric views of an alternative embodiment of the disclosed articulating mounted platform in accordance with the disclosure. The work platform 10 illustrated in FIG. 5 is substantially similar to that illustrated in FIG. 1, except that the wheels 17 and handrails 23 in FIG. 5 extended beyond the perimeter profile of frame 13. In addition, the height adjustment bar 11, as illustrated in FIG. 5 is substantially shorter than that shown in FIG. 1 and does not serve as a post for light 21. The height adjustment bar 11 configurations shown in FIG. 1, 5 or 12 may be adapted to work with either quick connect assembly 12 illustrated in FIG. 9 or 10.

FIG. 12 illustrate a rear isometric views of another alternative embodiment of the disclosed articulating mounted platform 10 in accordance with the disclosure. Work platform 10 of FIG. 12 does not have wheels 17 or light 21. In addition, the quick connect assembly 12 has a different configuration in which the extension arm assembly 14 is integrally formed within the quick connect assembly 12.

FIG. 8A-C illustrate side, bottom perspective and front perspective views, respectively, of a motorized articulating assembly 16 in according with one embodiment of the disclosure. Hitch assembly 16 comprises an extension arm 80, which in the illustrative embodiment comprises a pair of rectangular tubes 82A-B stacked vertically and secured together with a plate 84. The lower tube 84B extends beyond the end of 280 4K is shaped to be received within sleeve 114 of assembly 110. A guidepost 85 project downward from projects downward tube 82B and is received within the channel collector will collectively defined by plates 118 of assembly 110, the angular offset of guidepost 85 defining the angular adjustment of work platform 10 transverse to the centerline of vehicle 6, is adjusted using bolts 119 of assembly 110. A pair of top and bottom articulation plates 86A-B secured to tubes 82A-B, collectively and movably retain shaft 88 therebetween so as to allow rotation thereof.

The work platform 10 can be manually operated or, in alternative embodiments, be modified to allow for automatic rotation through either hydraulics or pneumatic, pistons or electric motors. In the embodiment illustrated in FIGS. 8A-C, a motor 87, which maybe any of electric, hydraulic, or other type of torque source is connected to shaft 88 through one ore gears, allowing shaft 88 to rotate extension arm assembly 14, pivotally secured between articulation plates 86A-B, between perpendicular angles relative to assembly 110. For more apertures extends through articulation plates 86A-B and extension arm assembly 14 and receive pins which secure work platform 10 in position on either the right or left side of the vehicle 6. In light of the disclosure herein, those reasonably skilled in the art will understand that articulation plates 86A-B may be modified to allow for extension arm assembly 14 and, ultimately, work platform 10 to be fixed at any position relative to the axis of the vehicle hitch by appropriately providing the correctly positioned apertures in plates 86. The power rating for motor 87 should be chosen to provide enough torque to efficiently move or platform 10.

FIG. 9A-C illustrate isometric, side and front views, respectively, of a quick connect assembly 90 according to another embodiment of the disclosure. In an illustrative embodiment, quick connect assembly 90 comprises a substantially rectangular hollow sleeve 92 having a pair of shim plates 94 secured to opposite interior surfaces thereof. A pair of apertures extend through the shim plates 94 and the sides of sleeve 92 to which each shim plate is attached. The apertures are sized and shaped to receive a pair of pins 36 to secure assembly 90 to the height adjustment bar 11 of work platform 10, similar to the previously described embodiments. Assembly 90 further comprises an insert arm 96 secured to sleeve 92 with a pair of doubbler plates 98 security each side thereof as well as to sleeve 92 well. Plural pairs of apertures extend through the sides of insert arm 96. One pair of apertures extends through doubbler plates 98 and the sides of insert arm 96 to which each doubbler plates is attached. These apertures are sized and shaped to receive a pair of pins 36 to secure assembly 92 to extension arm assembly 14 of work platform 10, similar to the previously described embodiments. Insert arm 96 has a tapered tip of center relative to a center axis thereof to facilitate guiding of tip 99 into one of the tubes of extension arm assembly 14.

FIG. 10 illustrates an isometric view of a quick connect assembly 100 according to another embodiment of the disclosure. Quick connect assembly 100 is similar in design and function to quick connect assembly 90, except that insert arm 106 of assembly 100 is shorter than insert arm 96 of the assembly 90. In addition, assembly 100 includes a vertical stiffening plate 105 which is secured atop doubbler plates 108 and partially around sleeve 102. In assembly 100, sleeve 102 has open side for facilitating rapid attachment to the height adjustment bar 11 of work platform 10.

FIG. 11A-D illustrate top, front, side and isometric views, respectively, of an alternative hitch and angular adjustment assembly 110 according to another embodiment of the disclosure. The angle adjustment assembly 110 may be used with any of the embodiments of work platform 10 disclosed herein. Angle adjustment assembly 110 comprises plate 112 having a sleeve 114 projecting therefrom at a right angle. A collar 116, having a diameter large enough to fit around the exterior of sleeve 114 is secured to the opened end of sleeve 114. A plurality of apertures extend through plate 112 and are sized and shaped for receiving bolts 115 therein to secure the assembly 110 to the frame of a vehicle, in a manner understood by those recently skilled in the arts. An angle adjustment mechanism 116 is the secured to an undersurface of sleeve 114 and comprises a pair of plates 118 which collectively defined a channel capable of receiving a guidepost 144 of hitch assembly 16. A pair of apertures sized and shaped for receiving bolts therein extended through plates 118 and are used to secure guidepost 144 therebetween.

FIG. 13A-D illustrate an optional angular adjustment assembly 130 which comprise 3¾″ thick 44,000 pound yield plates 132 with an aperture extending through each to receive 2⅝″ grade five bolts 134. Similar to assembly 110, the yield plates 132 are drilled and tapped to allow the bolts 134 to be tightened against the articulated hitch assembly 16, allowing for angular adjustment of the work platform 10 up to 5 degrees transverse to the vehicle centerline. This angular adjustment assembly 130 is meant to level the platform depending on the weigh of the operator/passenger.

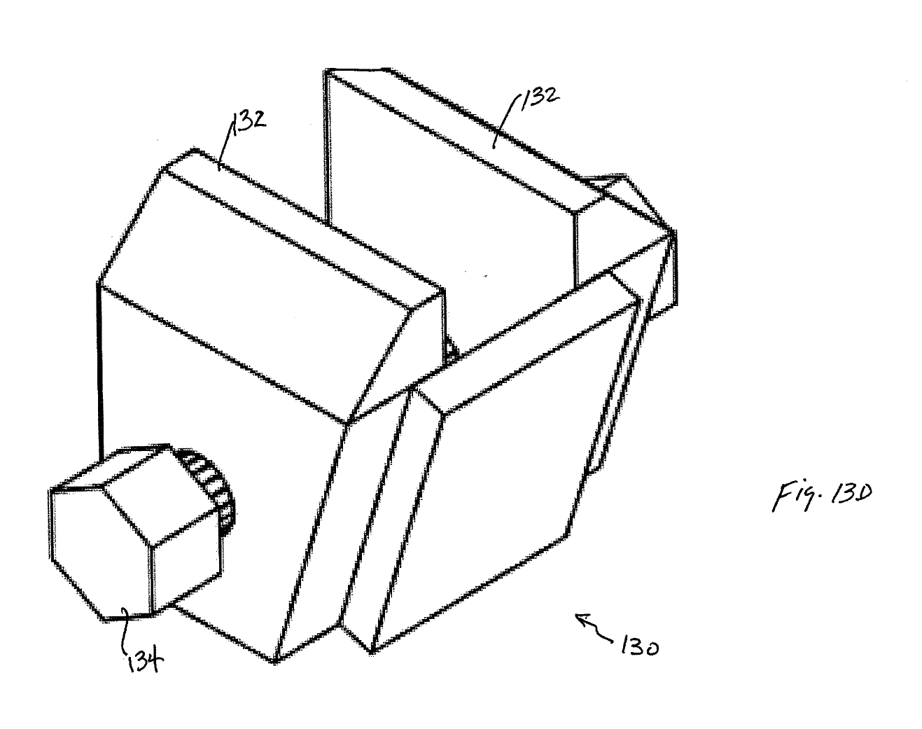

FIG. 14 illustrates schematically the electrical circuit 140 useful with the embodiments of disclosed herein. Specifically, running light lamp 141, brake light lamp 142, signal light lamp 143, amber light lamp 144, motor 145 and audio transducer 144 are each connected in parallel with a main bus 147 and a current source, here battery 148 of vehicle 6, through their own respective fuses, as well as a main fuse and switch 149, as illustrated. Circuit 140 requires little or no modification of the existing wiring and electrical system in most vehicles and may be connected thereto with a modular connector accessible from the rear or other portion of vehicle 6.

The reader will appreciate the FIGS. 1-7 illustrate an embodiment of the work platform 10 that includes a quick connect/release connection, which along with rollers 17, enables the work platform 10 to be moved and coupled to a vehicle by a single person.

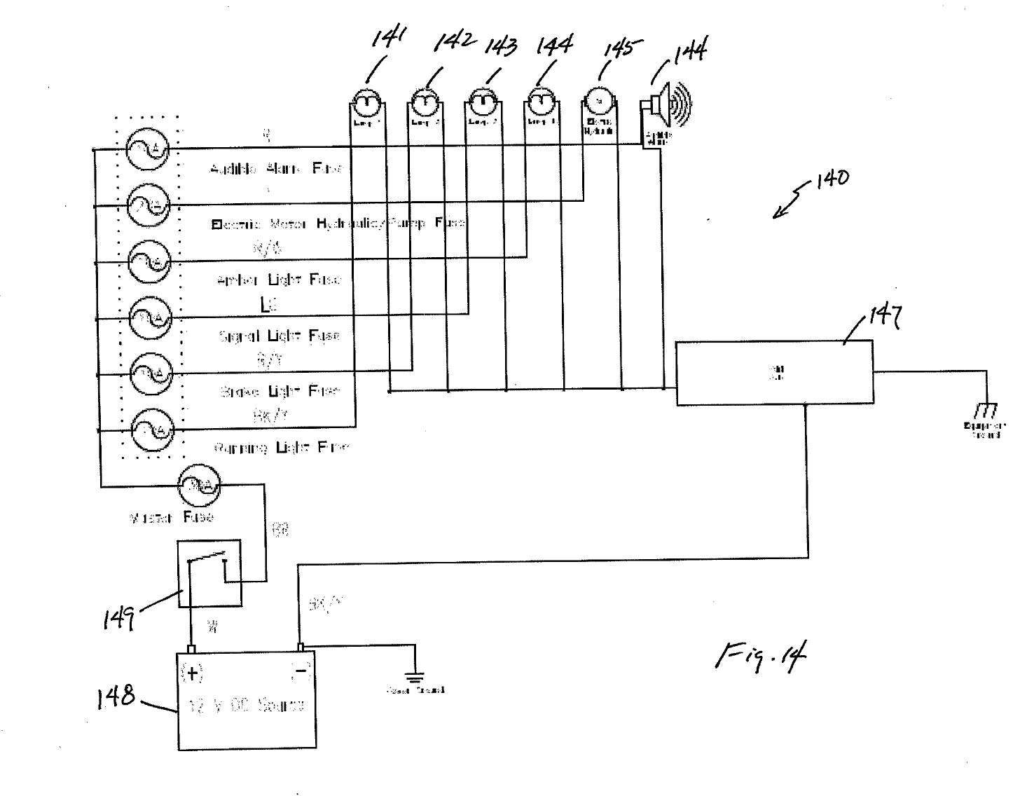

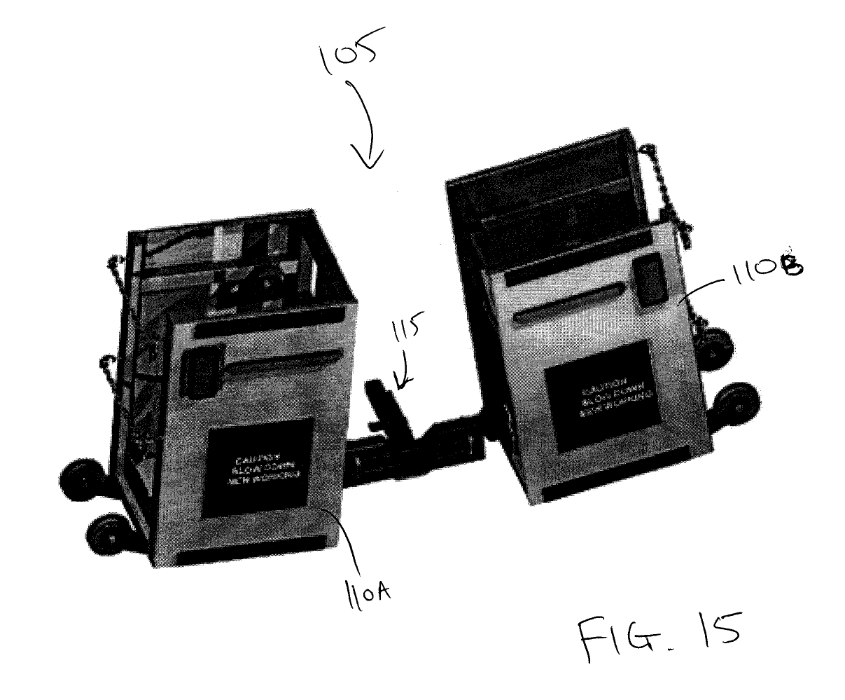

Referring now to FIG. 15, a front view of an alternative embodiment of the disclosed articulating mounted platform is shown. Specifically, FIG. 15 illustrates a front view of a dual-work platform system 105 that comprises a first work platform 110A, a second work platform 110B, and a connection assembly 115 for securing the work platforms 110A-B to a vehicle 6. The work platforms 110A-B may have embodiments with various configurations, as described above with reference to FIGS. 1-5 and 12. Additional details of the connection assembly 115 are provided below with respect to FIG. 16.

FIG. 16 illustrates a close-up perspective view of a connection assembly configured to couple work platforms to a vehicle. The connection assembly 115 comprises a first and second quick connect assembly 112A-B, an extension arm assembly 114 having a first attachment opening 140A coupled to the first quick connect assembly 112A and a second attachment opening 140B coupled to the second quick connect assembly 112B, a hitch assembly 116 and an angle adjustment assembly (not shown). The angle adjustment assembly may be similar to the angle adjustment assembly described herein. In various embodiments, the hitch assembly 116 may be articulated, while in other embodiments, the hitch assembly may be fixedly coupled to the vehicle hitch. The first and second quick connect assemblies 112A-B are slidably mounted to a corresponding frame of work platform 110A-B, respectively, using a plurality of pins so as to allow the height of work platforms 110A-B to be adjusted relative to the other components of connection assembly 115 and the vehicle hitch. An insert of each of the first and second quick connect assemblies 112A-B is configured to be received within a corresponding first and second extension arm assembly 140A-B. Assemblies 112A-B and 114 may be secured together using one or more pins, as illustrated. Assembly 112 may comprise either of the configurations described with reference to FIGS. 9 and 10, or, alternatively, as illustrated in FIG. 12.

Extension arm assembly 114 is mounted to articulated hitch assembly 116. The extension arm assembly 114 comprises a plurality of rectangular tubes 134A-B stacked vertically at a length designed to locate the work platforms 110A-B approximately flush with the outside of the vehicle 6. Assemblies 114 and 116 are removably secured using one or more pins, as illustrated. An arm of hitch assembly 116 is received within the vehicle hitch and its angular motion of constrained by angular adjustment assembly, as described herein. Hitch assembly 116 is designed to allow the extension arm assembly 114 to fit in the hitch assembly 116 and be locked into position by one or more lock pins. As used herein, the term “pins” may comprise any us straight pins, L-shaped pins or cotter pins, as illustrated in figures.

The work platforms 110A-B are attached to a vehicle 6 by way of connection assembly 15 which designed to allow the work platforms 110A-B to be raised or lowered relative to the road surface (or hitch). The extension arm assembly 114 of connection assembly 115 can be of varying lengths so as to accommodate the requirements of the vehicle width and fits into the vehicle hitch. Since there are two work platforms, there is no need for a rotation mechanism that allows any of the work platforms to move from one side of the vehicle to the other side of the vehicle. However, in various embodiments, the work platforms 110A-B may be configured to swivel about an axis of the respective quick connect assemblies 112A-B.

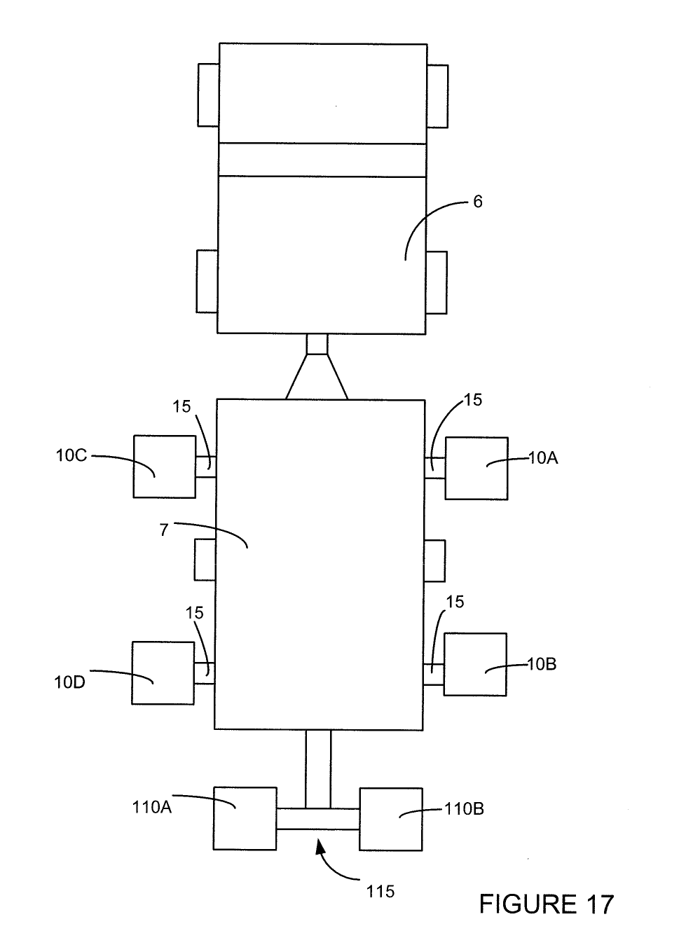

As used herein, the term “vehicle” may include any entity which is either self-propelled or capable of being towed and to which a hitch is attached or attachable. For example, a trailer 7 which is towable by a truck 6 may have one or more work platforms 10A-D, and corresponding respective connection assemblies 15, attached thereto to enable multiple road crew personnel to work simultaneously therefrom, as illustrated in FIG. 17. In addition, the vehicle may include one or more work platforms 110A-B, and corresponding connection assemblies 115 also illustrated in FIG. 17.

The disclosed system, apparatus and technique should not be restricted to any specific implementations here described, for which other beneficial or alternate implementations may be substituted, in order to satisfy the organizational, functional or structural requirements imposed upon the disclosed system. It will be apparent to those skilled in the art that modifications to the specific embodiments described herein may be made while still being within the spirit and scope of the teachings disclosed herein.

What is claimed is:

1. A work platform apparatus capable of attachment to a vehicle comprising:
a substantially rectangular-shaped frame;
and attachment mechanism configured to movably couple the frame to a hitch of the vehicle in a manner that allows multiple degrees of motion of the frame relative to the hitch.

2. The apparatus of claim 1 wherein the attachment mechanism is configured to enable adjustment of a height of the frame relative to the hitch.

3. The apparatus of claim 1 wherein the attachment mechanism is configured to enable adjustment of a distance of the frame relative to the hitch.

4. The apparatus of claim 1 wherein the attachment mechanism is configured to enable adjustment of an angular orientation of the frame relative to the hitch.

5. The apparatus of claim 1 further comprising:
a motor coupled to the attachment mechanism.

6. The apparatus of claim 5 wherein the motor is an electric motor.

7. The apparatus of claim 1 further comprising:
a pair of wheels coupled to the frame.

8. The apparatus of claim 1 wherein the frame has at least one surface on which an operator may stand.

9. The apparatus of claim 1 further comprising:
an audio transducer connectable to a current source.

10. The apparatus of claim 1 further comprising:
a light coupled to the frame and connectable to a current source.

11. A work platform apparatus capable of attachment to a hitch of a vehicle, the hitch attached to the vehicle at a height and extending along an axis relative to the vehicle, the work platform comprising:
a substantially rectangular frame having a base extending along a plane;
an extension arm coupling the frame to the hitch and configured to enable adjustment of a distance of the frame relative to the hitch;
an elevation mechanism coupled to the frame and configured to enable adjustment of a height of the frame relative to a plane of the hitch; and
an orientation mechanism coupled to the frame and configured to enable adjustment of an orientation of the frame relative to the hitch axis.

12. The apparatus of claim 11 further comprising:
an angular adjustment mechanism coupled to the extension arm for modifying the angular adjustment of the frame along an axis which is one of transverse or parallel to a centerline of the vehicle.

13. The apparatus of claim 11 further comprising:
a motor coupled to the attachment mechanism.

14. The apparatus of claim 13 wherein the motor is a hydraulic motor.

15. A method of attaching a work platform to a vehicle having a hitch comprising:
A) providing a work platform comprising:
i) a substantially rectangular-shaped frame;
ii) an attachment mechanism configured to modify a position of the frame with at least three degrees of freedom relative to the hitch; and
B) attaching the work platform to the vehicle hitch.

16. The method of claim 15 wherein C) comprises:
C1) configuring the adjustment mechanism to modify a height of the work platform relative to the vehicle hitch.

17. The method of claim 15 wherein C) comprises:
C1) configuring the adjustment mechanism to modify a distance of the work platform relative to the vehicle hitch.

18. The method of claim 15 wherein C) comprises:
C1) configuring the adjustment mechanism to modify an orientation of the work platform relative to the vehicle hitch.

19. The method of claim 15 wherein C) comprises:
C1) configuring the adjustment mechanism to modify an angular adjustment of the work platform along an axis which is one of transverse or parallel to the vehicle centerline.

20. The apparatus of claim 11 further comprising:
a second substantially rectangular frame coupled to the extension arm to enable adjustment of a distance of the second frame relative to the hitch and further coupled to the elevation mechanism to enable adjustment of a height of the second frame relative to a plane of the hitch; and
a second orientation mechanism coupled to the second frame and configured to enable adjustment of an orientation of the second frame relative to the hitch axis.
